(19) United States
(12) Patent Application Publication
(10) Pub. No.: US 2025/0189978 A1
(43) Pub. Date: Jun. 12, 2025

(54) ELECTRIC-DRIVE CONTROL SYSTEM WITH INBUILT GUIDANCE AND SAFETY MONITORING

(71) Applicant: EZ-WHEEL, LA COURONNE (FR)

(72) Inventors: Florian GARDES, GOND-PONTOUVRE (FR); Antoine JUAN, ANGOULEME (FR)

(21) Appl. No.: 18/840,168

(22) PCT Filed: Feb. 21, 2023
(86) PCT No.: PCT/FR2023/050246

§ 371 Date: Aug. 21, 2024

(30) Foreign Application Priority Data
Feb. 22, 2022 (FR) 2201551

(51) Int. Cl. G05D 1/622; B60L 15/20; B60L 50/60; B60L 53/14; B60L 58/12; G01S 17/931; G05D 105/28

(52) U.S. Cl. CPC G05D 1/622; B60L 15/20; B60L 50/60; B60L 53/14; B60L 58/12; G01S 17/931; B60L 2240/421; G05D 2105/28

(57) ABSTRACT

A control system for operating at least one electric motor for a self-guided vehicle, the system including: at least one electronic control interface each associated with an electric motor, at least one operational-safety processor connected to at least one electronic control interface in order to operate the at least one electric motor on the basis of safety information originating from a safety scanner and a guidance control processor which is configured to process environment information originating from the safety scanner.

### CROSS REFERENCE TO RELATED APPLICATIONS

This Application is a National Stage of International Application No. PCT/FR2023/050246, having an international filing date of 21 Feb. 2023, which designated the United States of America, and which International application was published under PCT Article 21(2) as WO Publication No. 2023/161584, which claims priority from and the benefit of French Patent Application No. 2201551 filed on 22 Feb. 2022, the disclosures of which are incorporated herein by reference in their entireties.

### BACKGROUND

### Field

The present disclosure relates to an electric-drive control system with integrated navigation and safety monitoring designed to drive a drive wheel of a vehicle.

### Brief Description of Related Developments

The present disclosure also relates to a self-drive assembly and to a self-guided vehicle equipped with such a drive control system.

A load transport vehicle, such as a picking trolley used in a storage warehouse or a trolley for transporting mechanical parts between two workstations in a factory, may be equipped with an electric-drive system, thus allowing a user to move the vehicle without exertion, or with limited exertion. However, it is noted that for example, in storage warehouses having long aisles, the use of such a practically manual trolley involves the operator traveling long routes, this resulting in fatigue and a loss of time when the route is not optimized. In addition, the operator has to perfectly know the location of the stored articles and the layout of the warehouse so as not to lose time.

In order to improve management of the logistic flow, use is made of technology for guiding by wire or by laser so as to guide the movement of the motorized trolleys in the workspace, for example in a warehouse in order to avoid the need for human intervention. Such technology is dependent on external elements or reference points arranged along the route traveled by the trolley, for example markers, buried wires, or a stripe of paint. Such guiding technology imposes a fixed trajectory and a specific infrastructure on the trolleys.

In order to be able to easily adapt the trajectory of the vehicle to the change in the workspace in which it is moving, autonomous mobile robots (AMRs) which move autonomously and freely in an environment such as storage warehouses without human intervention and without external elements by virtue of geoguidance technology have appeared in recent years.

Geoguidance technology is based on mapping the environment in which the vehicle is moving. It allows the vehicle to autonomously locate itself in the work environment and to automatically calculate its route. To do this, the vehicle is generally equipped with a lidar system which makes it possible to acquire a plurality of shots of the environment. These shots are then sent to a central computer located remotely to the vehicle so as to generate a virtual reconstruction of the environment by using an appropriate algorithm.

Nevertheless, in factories and warehouses, there may be operators and other vehicles which are moving therein. In such dynamic environments, it is therefore essential to be able to monitor the trajectory of the autonomous vehicle in order to guarantee its correct operation while guaranteeing the safety of the moving operators. Information called safety information which is acquired by the lidar system or other sensors is sent to a controller coupled to the drive system which is capable of disconnecting the power supply to the motors or of engaging a braking system so as to slow down the vehicle when an obstacle is detected in a predefined area.

Currently, the enhanced environment information and the safety information are processed by a set of distinct modules. The navigation function and the safety function are thus ensured by distinct and different devices. In other words, the autonomous vehicle is equipped with a navigation system and a safety system in order to ensure its movement in the environment. This thus results in a large number of necessary modules in order to ensure the safety and navigation functions, forming a fragmented, relatively complex and expensive architecture which is not very suitable for complete integration in a wheeled apparatus, such as a light load-carrying vehicle or a mobile robot.

The present disclosure aims to overcome these drawbacks by proposing a drive control system which makes it possible to integrate and combine together the safety-monitoring function and the navigation function in a single module, while having a reduced size and end cost.

### SUMMARY

The present disclosure will improve the situation.

A system for controlling at least one electric motor for a self-guided vehicle is proposed, said system comprising:
at least one electronic control interface each associated with an electric motor, at least one operational-safety processor connected to at least one electronic control interface so as to control said at least one electric motor on the basis of safety information originating from a safety scanner and a navigation-monitoring processor which is configured to process environment information originating from the safety scanner.

According to one aspect, the at least one control interface comprises two electronic control interfaces each associated with an electric motor, the safety processor being connected to the two electronic control interfaces so as to control the two motors on the basis of safety information transmitted by the scanner.

According to another aspect, the at least one control interface comprises two electronic control interfaces each associated with an electric motor and the at least one operational-safety processor comprises two safety processors, each of the two processors being connected to an electronic control interface so as to control the two motors on the basis of safety information transmitted by the scanner.

The features set forth in the following paragraphs may optionally be implemented independently of one another or in combination with one another.

The safety processors are configured to determine whether an obstacle is detected in a field of view of the safety scanner on the basis of safety information received and carry out at least one safety function from among the following safety functions:
an “STO” safety function corresponding to electrically disconnecting the motor so as to eliminate the torque;
an “SDI” safety function corresponding to preventing one of the two rotation directions of the motor;
an “SLS” safety function corresponding to limiting the rotation of the motor to a maximum speed;
an “SS1” safety function corresponding to braking the motor by controlled deceleration;
an “SBC” safety function corresponding to stopping the motor by engaging a brake.

The navigation-monitoring processor is configured to monitor the navigation of the vehicle by carrying out the following navigation functions:
calculating at least one trajectory to be performed by the vehicle in an environment on the basis of information transmitted by a central monitoring unit;
reading enhanced information about the environment, which enhanced information is acquired by said at least one safety scanner while the vehicle is moving in the environment;
reconstructing the environment and determining the position of the vehicle in said environment;
predicting at least one path to be followed by the vehicle and adapting the trajectory to the environment.

According to another aspect, a self-drive assembly for a self-guided vehicle is proposed, comprising:
at least one electric motor generating a rotation movement;
an energy source configured to store and return the energy needed for the autonomous operation of said assembly;
a system for controlling said at least one electric motor as defined above.

According to one aspect of the disclosure, the assembly comprises a base frame and an external profiled shell forming an external casing, the base frame comprising a receiving space for receiving the electric motor and keeping it in position, a first internal profiled shell and a second internal profiled shell assembled together to form a tight internal casing in which are received the energy source, the control system, said casing also being received in the receiving space of the external casing.

Preferably, the second internal profiled shell forms a user interface comprising communication connections, a recharging connection and a means for indicating the state of charge of the energy source, said user interface being positioned facing an opening made in the external profiled shell such that the recharging connection and the indicating means are accessible and visible from outside the casing.

According to one aspect, the energy source comprises at least one accumulator of Ni-MH or Li-ion type.

Preferably, the electric motor is coupled to a drive wheel by way of an epicyclic reduction gear.

According to another aspect, a self-guided vehicle comprising at least one drive wheel driven by a self-drive assembly as defined above, and at least one safety scanner configured to acquire safety information and enhanced information about the environment in which said vehicle is moving is proposed.

According to one aspect, said safety scanner is connected to the safety-monitoring processor and to the navigation-monitoring processor via a bus for communicating safety information and a bus for communicating enhanced information about the environment, respectively.

Preferably, said at least one safety scanner is a lidar system.

### BRIEF DESCRIPTION OF THE DRAWINGS

Other features, details and advantages will become apparent on reading the detailed description below and on analyzing the appended drawings, in which:

FIG. 1 shows a drive control system according to one aspect.

FIG. 2 shows a drive control system according to a second aspect.

FIG. 3 shows a drive control system according to a third aspect.

FIG. 4 shows an exploded view of a self-drive assembly comprising a drive control system of FIG. 1.

FIG. 5 schematically depicts a top view of a handling vehicle with automatic guidance, equipped with a drive wheel driven by a drive control system of FIG. 1.

FIG. 6 schematically depicts a perspective view of a self-guided handling vehicle comprising two motors driven by a drive control system according to one aspect.

### DETAILED DESCRIPTION

In the various figures, the same references denote identical or similar elements.

Within the scope of the present disclosure, the environment denotes for example a warehouse, a production factory, or any other industrial space in which a light vehicle moves.

Within the scope of the present disclosure, the light vehicle which moves autonomously in an environment may for example be a handling trolley or any other wheeled handling apparatus or a mobile robot.

Within the scope of the present disclosure, a safety scanner is a device for perceiving the environment commonly used in autonomous mobile robotics, making it possible, on the one hand, to have operational-safety information relating to the presence of an obstacle in preconfigured risk areas and, on the other hand, to send back distance information, called enhanced information about the environment with respect to the surrounding elements. The safety information is usually used for the purpose of preventing dangerous actions or of engaging safety devices. The non-safety, distance information is able to be used to reconstruct a map of the environment and calculate a position with respect to the environment, useful information for the navigation of autonomous mobile apparatuses.

Within the scope of the present disclosure, “enhanced information about the environment” is understood to mean a set of coordinates of the points detected in the field of view of one or more safety scanners which are able to capture shots of the environment of the device. This information is used to feed and enhance the navigation algorithms of the vehicle in order to recreate the environment in which the vehicle is moving and the position of the acquisition device in the recreated environment.

With reference to FIG. 1, a drive control system 1 for a light self-guided vehicle in accordance with one aspect is depicted.

The control system 1 has the function of controlling the motors of the vehicle on the basis of safety information and enhanced information about the environment, both transmitted by a safety scanner 5.

According to the disclosure, the drive control system 1 is integrated directly in a self-drive assembly 20 so as to drive one or two drive wheels, for example. In the example of FIG. 1, the assembly 20 is configured to drive one drive wheel 201.

The autonomous assembly 20 will be described in more detail below with reference to FIG. 4. It may comprise an electric motor 22 configured to generate a rotation movement, an energy source 21 which stores and returns the energy needed for the autonomous operation of the autonomous assembly.

The safety scanner 5 is able to capture information about the environment in which the light vehicle is moving. The safety scanner may comprise but is not limited to a camera for shooting in two dimensions, a camera for shooting in three dimensions, a lidar system or any other equivalent system for acquiring a plurality of shots of the environment. The data from the scanner 5 may be of two distinct types. The data may comprise safety information indicating for example a presence detected in a predefined area, indicating a safety risk and enhanced information about the environment, which enhanced information comprises all the physical points detected in the field of detection of the scanner 5.

The drive control system 1 comprises an electronic control interface 3 configured to control the operation of the motor 22, an operational-safety processor 2 connected to the electronic control interface 3 so as to control the motor 22 on the basis of safety information originating from the scanner 5. The control system 1 also comprises a navigation-monitoring processor 4 configured to monitor the navigation of the vehicle on the basis of enhanced information about the environment, this information originating from the scanner 5. The processed information allows the drive control system 1 to have a dual function, controlling the operation of the motor depending on safety information and guiding the vehicle by recreating the environment in which the apparatus is moving.

The safety information and the enhanced information about the environment are processed by two distinct processors, the operational-safety processor 2 for the motor and the navigation-monitoring processor 4 which are both integrated in one and the same physical entity, the control system 1 for the motor. Advantageously, the operational-safety processor 2 and the navigation-monitoring processor 4 may thus be integrated together in a single device. Unlike the known solutions which propose different and distinct devices for ensuring the navigation and safety functions, these functions are ensured by a single device. Bringing together the safety-monitoring processor and the operational-safety processor in the drive system allows one and the same system to process both the environment information and the safety information originating from the sensors. This integration makes the drive system more generic and directly compatible with safety scanners.

The operational-safety processor 2 is coupled to the motor 22 by way of the electronic control interface 3. The operational-safety processor 2 controls the electronic control interface 3 so as to monitor the motor 22 and integrates at least one of the following safety functions:
electrically disconnecting the motor 22 so as to eliminate the torque, corresponding to the STO (Safe Torque Off) safety function,
preventing one of the two rotation directions if an obstacle is present on one side of the vehicle, corresponding to the so-called SDI (Safe Direction) safety function,
limiting the rotation to a maximum speed thus making it possible to transition into a safe limited-speed mode when an obstacle is detected in the field of vision, corresponding to the so-called SLS (Safety Limited Speed) safety function,
braking the motor by controlled deceleration if an imminent obstacle is detected, corresponding to the so-called SS1 (Safe Stop) safety function,
stopping the motor by engaging a brake, corresponding to the so-called SBC (Safe Brake Control) safety function.

The operational-safety processor 2 is connected to the safety scanner 5 via a link 7 for transmitting safety information or via a communication bus 7. The safety functions may be activated independently depending on the safety information transmitted by the scanner 5 to the operational-safety processor 2. The communication bus may be for example a communication network dedicated to safety such as CANopen Safety, PROFIsafe or FSoE (Fail Safe over Ethercat).

According to one exemplary aspect, when the SLS safety function is activated and the motor control is in limited-speed mode, the safety-monitoring processor transmits information to the scanner 5 asking it to reduce the distances of the fields of detection. According to another exemplary aspect, when the rotation speed of the two drive wheels is different, the safety-monitoring processor transmits information to the scanner 5 asking it to adapt the position of the fields of detection to the orientation imposed by the speed differential of the drive wheels.

The navigation-monitoring processor 4 is configured to monitor the navigation of the vehicle on the basis of enhanced environment information originating from the scanner 5.

The navigation-monitoring processor 4 is configured to carry out the monitoring of the navigation of the vehicle on the basis of enhanced information about the environment, this information originating from the data acquisition device 5:
calculating at least one trajectory to be performed by the vehicle in the environment;
reconstructing the environment;
determining the position of the vehicle in said reconstructed environment;
predicting at least one path to be followed by the vehicle and adapting the trajectory to the environment.

The navigation-monitoring processor 4 is also configured to be able to communicate with a fixed central unit 71 positioned remotely to the vehicle as illustrated in FIG. 6. The navigation-monitoring processor 4 receives the task commands to be performed by the vehicle and also a database representing the coordinates of points of the environment in which the vehicle has to move. The navigation-monitoring processor 4 processes the task commands to be performed by said vehicle and determines a trajectory to be undertaken in the environment.

In order to generate a reconstruction of an environment on the basis of enhanced information about the environment, which enhanced information may be for example from various shots, there are several algorithms from the prior art which may be used depending on the envisaged sensor for the system for perceiving the environment. For example, if the sensor for perceiving the environment is a camera or a lidar, then algorithms of “SLAM” type make it possible to obtain a two-dimensional or three-dimensional reconstruction of the environment. In the context of a sensor of lidar or laser type, the various individual reconstructions may be assembled into a single overall reconstruction by using an approach of ICP (Iterative Closest Point) type.

The navigation-monitoring processor 4 and the scanner 5 are connected by a data transmission link 6, thus allowing the navigation-monitoring processor 4 to access the data measured by the scanner 5 but also to transmit data to the scanner 5.

The navigation-monitoring processor 4 and the safety processor 2 are connected together via a link 8 which may be a non-safety communication bus of serial bus, CANopen, PROFInet or EtherCAT type, for example.

In the known solutions, the safety information and the enhanced information about the environment are processed by different devices. The safety information is generally sent to a safety logic which is capable of disconnecting the power supply to the motors or of engaging the braking of the motor, whereas the enhanced information about the environment is processed by a computation unit external to the vehicle. In a vehicle navigating in an autonomous manner, a large number of devices are required to ensure all of the safety and navigation functions. By virtue of the specific unitary architecture of the drive control system of the present disclosure, it is thus possible to combine the safety-monitoring functions and the navigation functions in a single and compact physical entity, thus giving the drive system of the present disclosure a modular nature.

The drive control system according to the present disclosure is particularly suited to being integrated in a self-drive assembly so as to drive a drive wheel of a light vehicle. One of the main advantages of the present system is its simplicity in its architecture and its implementation while guaranteeing automatic guidance and its safety in a dynamic environment.

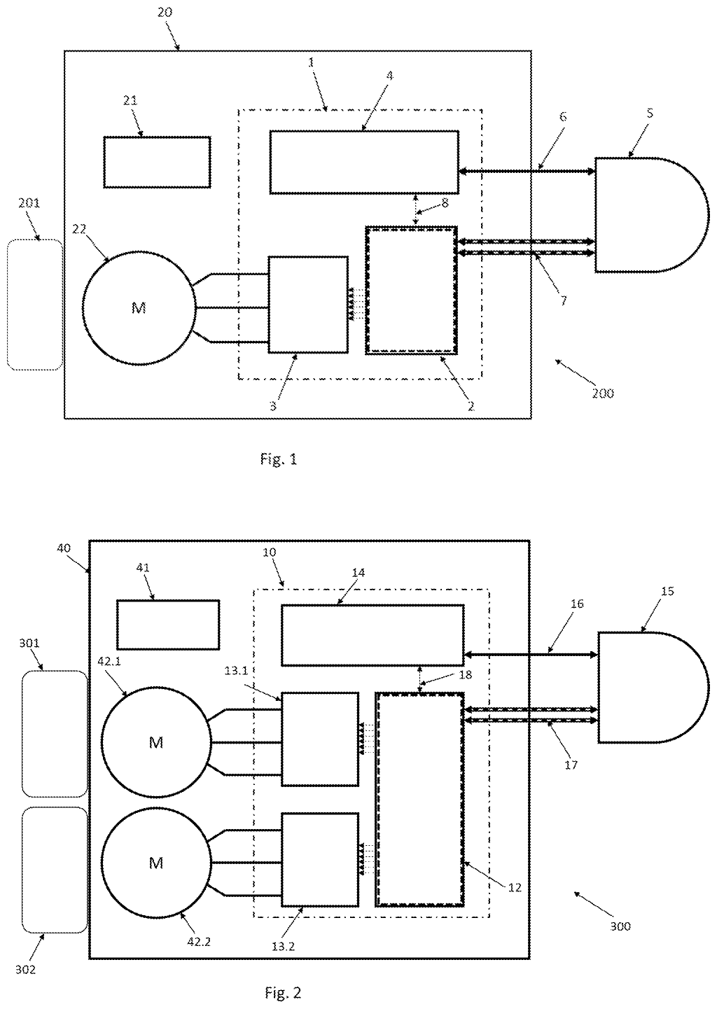

With reference to FIG. 2, a drive control system 10 according to a second aspect is illustrated.

The drive control system of FIG. 2 makes it possible to control two electric motors 42.1, 42.2 of a self-drive assembly 40 so as to drive the drive wheels 301, 302 of a vehicle 300. The assembly 40 further comprises a rechargeable energy source 41 so as to supply power to the motors.

The control system 10 comprises a first electronic control interface 13.1 coupled to a first motor 42.1 and a second electronic control interface 13.2 coupled to a second motor 42.2, a safety processor 12 connected to the two control interfaces 13.1, 13.2 so as to control the two motors 42.1, 42.2 on the basis of safety information originating from the safety scanner 15.

The control system also comprises a navigation-monitoring processor 14 configured to process enhanced information about the environment, this information originating from the scanner 15.

The operational-safety processor 12 is connected to the safety scanner 15 via a link 17 for transmitting safety information or via a communication bus 17. The safety functions may be activated depending on the safety information transmitted by the scanner 15 to the operational-safety processor 12. The communication bus may be for example a communication network dedicated to safety such as CANopen Safety, PROFIsafe or FSoE (Fail Safe over Ethercat).

The navigation-monitoring processor 14 and the scanner 15 are connected together by a data transmission link 16 such as Ethernet or USB, thus allowing the navigation-monitoring processor 14 to access the data measured by the scanner 15 but also to transmit data to the scanner 15.

The navigation-monitoring processor 14 and the safety processor 12 are connected together via a link 18 which may be a non-safety communication bus of serial bus, CANopen, PROFInet or EtherCAT type, for example.

Advantageously, the architecture of the control system is particularly flexible. The number of electronic control interfaces may thus be adjusted depending on the number of motors to control.

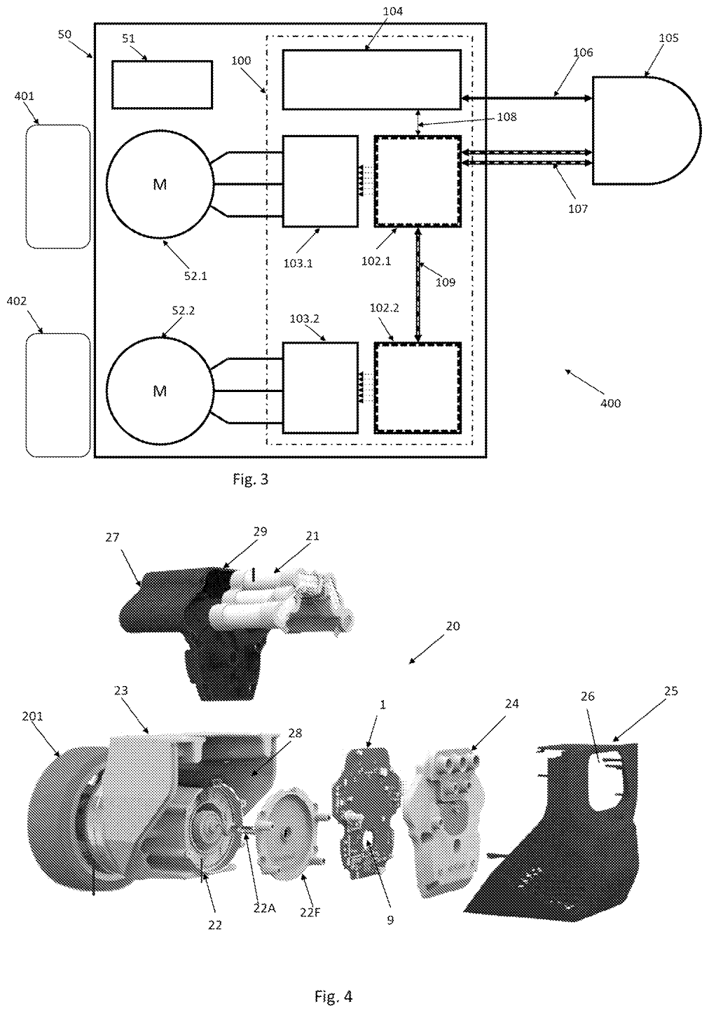

With reference to FIG. 3, a drive control system 100 according to a third aspect is illustrated.

The drive control system 100 of FIG. 3 also makes it possible to control two electric motors 52.1, 52.2 of a self-drive assembly 50 so as to drive the two drive wheels 401, 402 of a vehicle 400. The assembly 50 further comprises a rechargeable energy source 51 so as to supply power to the motors.

The control system 100 comprises a first electronic control interface 103.1 coupled to a first motor 52.1 and a second electronic control interface 103.2 coupled to a second motor 52.2, a first operational-safety processor 102.1 connected to the first control interface 103.1 and a second operational-safety processor 103.2 connected to the second control interface 103.2 so as to control the two motors 52.1, 52.2, respectively, on the basis of safety information originating from the safety scanner 105.

The control system also comprises a navigation-monitoring processor 104 configured to process enhanced information about the environment, this information originating from the scanner 105.

In this configuration, the scanner 105 is connected solely to the first operational-safety processor 102.1 and to the navigation-monitoring processor 104 of the system 100 via a bus 107 for communicating safety information and a bus 106 for communicating enhanced information about the environment, respectively. The first safety processor 102.1 is connected to the second operational-safety processor 102.2 via a bus 109 for communicating safety information in order to transmit the safety information originating from the scanner 105.

The navigation-monitoring processor 104 and the first safety processor 102.1 are connected together via a link 108 which may be a non-safety communication bus of serial bus, CANopen, PROFInet or EtherCAT type, for example.

The drive control system of the present disclosure is in the form of a control board which may be easily integrated along with the motor or the motors and a rechargeable energy source in a casing so as to form a self-drive assembly.

With reference to FIG. 4, an exploded view illustrates an exemplary aspect of a self-drive assembly 20 integrating the drive control system which may be the control system of one of FIGS. 1 to 3.

The assembly 20 comprises an external casing which supports and brings together all of the elements so as to drive and control the drive wheel 201, that is to say one or more electric motors 22, which may generate a rotation movement, an energy source 21, the control system 1 of the electric motor, which is in the form of an electronic board, and an interface 24 for managing the elements.

The energy source 21 comprises rechargeable accumulators which are capable of storing and returning the energy needed for the autonomous operation of the self-drive assembly 20. According to one exemplary aspect, the accumulators comprise an Ni-MH battery. According to another exemplary aspect, the accumulators comprise an Li-ion battery.

The external housing is formed of a base frame 23 and of an external shell 25 which are assembled and fixed together. The base frame 23 comprises a receiving space 28 for receiving an internal casing formed of a first internal profiled shell 27 and a second internal profiled shell 24 which is fitted onto the first shell 27. The first profiled shell 27 is dimensioned and configured to be fitted in the receiving space 28 of the base frame 23. The base frame 23 also supports the drive wheel 201 and comprises a housing delimited by the internal casing and designed to receive the electric motor 22. The wall of the interior shell 27 thus forms an interface between the energy source 21 and the motor 22. The interior shell 27 also comprises a receiving space 29 for receiving the energy source 21 and the control system 1.

The first shell 27 may be made of an electrically insulating material and possesses enhanced mechanical properties which make it possible to ensure holding of the elements and resistance to mechanical stresses suffered such as vibrations and/or shocks during operation. The material of the casing is for example a composite material. It may be made of plastic reinforced by glass fibers.

Preferably, the two internal profiled shells 27 and 24 comprising the electronic system 1 may be fitted together so as to obtain a tight casing. In addition, seals are positioned between the two shells and the parts which make up the casing.

The electric motor 22 comprises a motor shaft 22A. The control system 1 of the motor, which is in the form of an electronic board, comprises a hole 9 through which the shaft of the motor shaft is received. A flange 22F is arranged on one face of a motor casing, at an axial end of the motor so as to make an interface between the rear end of the motor 22 and the electronic board 1. The electronic system 1 comprises the power electronic interface 3, the operational-safety processor 2 and the navigation-monitoring processor 4 so as to control the electric motor 22 depending on the safety information and enhanced information about the environment, this information originating from the scanner 5. The electronic system 1 also comprises a communication interface, for example a Wifi connection so as to transmit data to a fixed central unit 71 as illustrated in FIG. 6. The electronic system I may be made up of a plurality of electronic boards assembled with one another.

According to one exemplary aspect, the second internal profiled shell 24 is fitted with a managing interface of the casing and may comprise for example communication interface connections, a recharging connection and a means for indicating the operating state and state of charge of the energy source. The managing interface 24 is positioned facing an opening 26 made in the external profiled shell 25 such that the communication connections, the recharging connection and the indicating means are accessible and visible from outside the casing.

The wheel 201 is coupled to the electric motor 22 of the self-drive assembly 20 via an epicyclic reduction gear not depicted in FIG. 4. The wheel 201 may be a non-directional drive wheel which makes the vehicle move forward or move back in a main direction of movement associated with the vehicle, the movement direction being perpendicular to the axis of rotation of the non-directional wheels. The wheel may be a directional motor. The wheel is orientable by pivoting around a vertical pivoting axis in order to direct the vehicle along its route.

The architecture of the self-drive assembly of the present disclosure is particularly advantageous. Specifically, it makes it possible to assemble all of the elements of the drive assembly in a single casing forming a single modular functional block which will be coupled to the wheel. In addition, the elements of the self-drive assembly are contained in a robust and completely tight fairing, allowing the wheel to operate in the harshest environments.

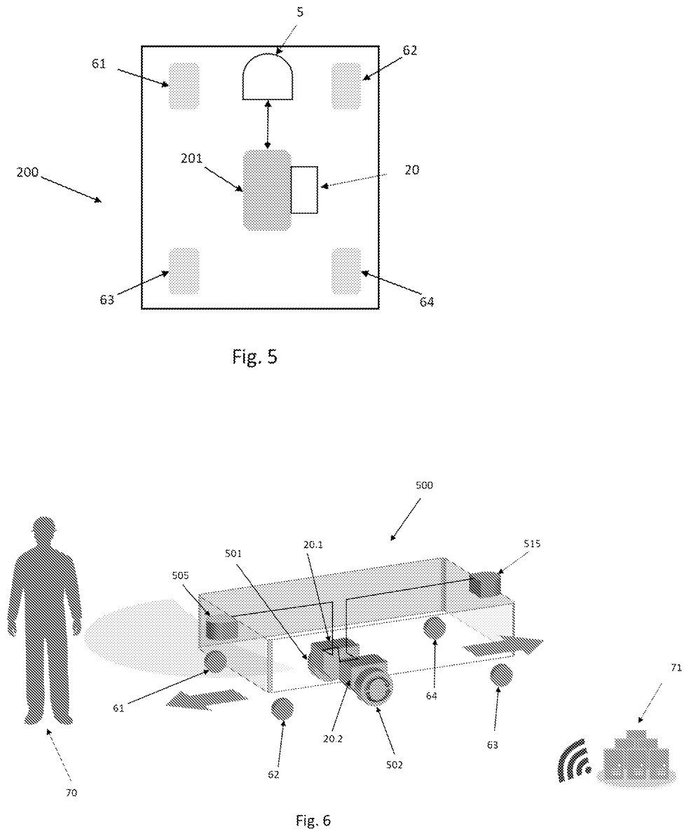

With reference to FIG. 5, an exemplary drive architecture of a light vehicle 200 equipped with a self-drive assembly of FIG. 4 is described below.

Generally, one or more drive wheels may be used to give a traction or propulsion function to the movement of a wheeled apparatus. The wheeled vehicle may move on a single autonomous drive wheel, on several drive wheels, on a set of drive and non-drive wheels. The wheels may be fixed or pivoting. A fixed wheel is understood to mean a wheel that keeps the same orientation with respect to the base of the apparatus regardless of the direction of movement of the apparatus. A pivoting wheel is understood to mean a wheel that has a horizontal axle pivoting around a vertical axle so as to make it possible to change the direction of movement of the apparatus to which the wheel is fixed. The axle of the wheel is a horizontal axle passing through the center of rotation of the wheel.

Depending on the geometry of the vehicle, the number of wheels and the distribution of the load, several layouts of drive wheels may be considered so as to ensure correct operation of the drive wheel or wheels.

In FIG. 5, the wheeled vehicle 200 comprises four non-drive pivoting wheels 61, 62, 63, 64 and one drive wheel 201. The drive wheel is arranged in a central position with respect to the base of the vehicle and allows electrical assistance for moving the apparatus. The wheel 201 is coupled by way of an epicyclic reduction gear to the self-drive assembly 20 of FIG. 4. The wheeled vehicle 200 further comprises a safety scanner 5 configured to acquire safety information and enhanced information about the environment in which the self-guided vehicle is moving.

With reference to FIG. 6, the steps for implementing a self-guidance method for a light vehicle 500 equipped with a drive assembly of the present disclosure are described below.

The light vehicle 500 is equipped with four fixed wheels 61, 62, 63, 64 and two drive wheels 501, 502. The two drive wheels are each equipped with a self-drive assembly 20.1, 20.2 of FIG. 4. The front and rear of the vehicle are equipped with a safety scanner 505, 515.

In a first step, a fixed navigation-monitoring central unit 71 transmits task commands to the navigation-monitoring processors of the two self-drive assemblies 20.1, 20.2. By way of example, the task commands may be the path that is to be traveled between a starting position A and a finishing position B according to a given trajectory. Moreover, the navigation-monitoring central unit 71 also transmits a database representing the environment in which the vehicle is moving. By way of example, the database is in the form of a 3-dimensional point cloud.

In a second step, the navigation-monitoring processors calculate the trajectory which is transmitted in the form of instructions to the safety processors which control the motors so as to move the vehicle in the environment.

In a third step, while the vehicle is moving, one of the scanners 505, 515 acquires information about the environment on the basis of a plurality of shots of the environment. In FIG. 6, this is for example the scanner referenced 505 which is activated to take the shots while the vehicle is moving. By way of example, if the scanner is made up of a camera or of a lidar, a plurality of images of the environment are acquired. This plurality of images may for example be of one and the same scene taken from various spatial viewpoints. The information is made up of enhanced information about the environment and of safety information.

In a fourth step, the scanner 505 transmits the enhanced information about the environment to the navigation processors 4 and the safety information to the operational-safety processors 2.

In a fifth step, the navigation-monitoring processors use the received enhanced information about the environment to carry out the following navigation functions: reconstructing the environment on the basis of the enhanced information about the environment, determining the position of the vehicle in this reconstructed environment and predicting a path to be followed by the vehicle and adapting the route with respect to the reconstructed environment. The operational-safety processors use the received safety information to carry out one of the safety functions. According to one configuration, if the safety processors determine, on the basis of the safety information, that an obstacle is present on one side of the vehicle, they transmit a control signal to the control interface 3 so as to prevent one of the two rotation directions. According to another configuration which is illustrated in FIG. 6, if an obstacle, for example an operator 70, is detected in the field of vision, the safety processors transmit a signal to the control interface 3 so as to limit the rotation speed of the two drive wheels 501, 502. According to yet another configuration, if the obstacle is detected within an immediate distance to the vehicle, the processors may activate the SS1 function so as to engage braking of the motor by controlled deceleration.

In a sixth step, when the vehicle arrives at the destination, the self-drive assemblies stop the motors.

While the vehicle is moving, the drive control systems 1 may communicate with the fixed remote central unit 71 so as to exchange data.

### Industrial Application

The present technical solutions may be used in various fields of industrial application, such as the automotive industry, the food processing industry, the logistics industry, so as to equip apparatuses of the industrial handling trolley type so as to transport spare parts or articles between workstations or work units in order to optimize the logistic flow while maintaining the safety of the operators.

What is claimed is:

1. A system for controlling at least one electric motor for a self-guided vehicle, said system comprising:
-at least one electronic control interface each associated with an electric motor, at least one operational-safety processor connected to at least one electronic control interface so as to control said at least one electric motor on the basis of safety information originating from a safety scanner and a navigation-monitoring processor which is configured to process environment information originating from the safety scanner.

2. The system as claimed in claim 1, wherein the at least one control interface comprises two electronic control interfaces each associated with an electric motor, the safety processor being connected to the two electronic control interfaces so as to control the two motors on the basis of safety information transmitted by the scanner.

3. The system as claimed in claim 1, wherein the at least one control interface comprises two electronic control interfaces each associated with an electric motor and the at least one operational-safety processor comprises two operational-safety processors, each of the two operational-safety processors being connected to an electronic control interface so as to control the two motors on the basis of safety information transmitted by the scanner.

4. The system as claimed in claim 1, wherein said at least one safety processor is configured to determine whether an obstacle is detected in a field of view of the safety scanner on the basis of safety information received and carry out at least one safety function from among the following safety functions:
an “STO” safety function corresponding to electrically disconnecting the motor so as to eliminate the torque;
an “SDI” safety function corresponding to preventing one of the two rotation directions of the motor;
an “SLS” safety function corresponding to limiting the rotation of the motor to a maximum speed;
an “SS1” safety function corresponding to braking the motor by controlled deceleration; and
an “SBC” safety function corresponding to stopping the motor by engaging a brake.

5. The system as claimed in claim 1, wherein the navigation-monitoring processor is configured to monitor the navigation of the vehicle by carrying out the following navigation functions:
calculating at least one trajectory to be performed by the vehicle in an environment on the basis of information transmitted by a central monitoring unit;
reading enhanced information about the environment, which enhanced information is acquired by said at least one safety scanner while the vehicle is moving in the environment;
reconstructing the environment and determining the position of the vehicle in said environment; and
predicting at least one path to be followed by the vehicle and adapting the trajectory to the environment.

6. A self-drive assembly for a self-guided vehicle, comprising:
at least one electric motor generating a rotation movement;
an energy source configured to store and return the energy needed for the autonomous operation of said assembly; and
a system for controlling said at least one electric motor as claimed in claim 1.

7. The assembly as claimed in claim 6, comprising a base frame and an external profiled shell forming an external casing, the base frame comprising a receiving space for receiving the electric motor and keeping it in position, a first internal profiled shell and a second internal profiled shell assembled together to form a tight internal casing in which are received the energy source, the control system, said casing also being received in the receiving space of the external casing.

8. The assembly as claimed in claim 7, wherein the second internal profiled shell forms a user interface comprising communication connections, a recharging connection and a means for indicating the state of charge of the energy source, said user interface being positioned facing an opening made in the external profiled shell such that the recharging connection and the indicating means are accessible and visible from outside the casing.

9. The assembly as claimed in claim 6, wherein the energy source comprises at least one accumulator of Ni-MH or Li-ion type.

10. The assembly as claimed in claim 6, wherein the electric motor is coupled to a drive wheel by way of an epicyclic reduction gear.

11. A self-guided vehicle comprising at least one drive wheel driven by a self-drive assembly as claimed in claim 6, and at least one safety scanner configured to acquire safety information and enhanced information about the environment in which said vehicle is moving.

12. The vehicle as claimed in claim 11, wherein said safety scanner is connected to the safety-monitoring processor and to the navigation-monitoring processor via a bus for communicating safety information and a bus for communicating enhanced information about the environment, respectively.

13. The vehicle as claimed in claim 11, wherein said at least one safety scanner is a lidar system.
